(19) United States
(12) Patent Application Publication
(10) Pub. No.: US 2018/0137413 A1
(43) Pub. Date: May 17, 2018

(54) DIVERSE ACTIVATION FUNCTIONS FOR DEEP NEURAL NETWORKS

(71) Applicant: NOKIA TECHNOLOGIES OY, ESPOO (FI)

(72) Inventor: YAZHAO LI, TIANJIN (CN)

(21) Appl. No.: 15/352,939

(22) Filed: Nov. 16, 2016

(51) Int. Cl. G06N 3/08

(52) U.S. Cl. CPC G06N 3/08

(57) ABSTRACT

In accordance with an example embodiment of the present invention, a method comprising: obtaining a plurality of training samples; employing a set of activation functions on a plurality of layers of a deep neural network, wherein the set of activation functions varies with the plurality of layers; and applying the activation functions on the plurality of training samples.

### TECHNICAL FIELD

The present application relates to machine learning and, in particular, diverse activation functions for deep neural networks.

### BACKGROUND

Deep learning algorithms have achieved state-of-the-art performance in the fields of image recognition, acoustic recognition, and other artificial intelligence. Representative applications include visual surveillance, optical character recognition, biometrics, robots, human-machine interactions, self-driving cars, and Go contest.

Activation function plays an important role in deep learning. It nonlinearly transforms the inner product between the neurons and their weights (the weights form a filter). It is the activation function that makes the deep learning capable of extracting nonlinear features which contribute much to boost the recognition performance.

### SUMMARY

Various aspects of examples of the invention are set out in the claims.

According to a first aspect of the present invention, a method comprising: obtaining a plurality of training samples; employing a set of activation functions on a plurality of layers of a deep neural network, wherein the set of activation functions varies with the plurality of layers; and applying the activation functions on the plurality of training samples.

According to a second aspect of the present invention, A non-transitory computer storage medium encoded with a computer program, the program comprising instructions that when executed by one or more computers cause the one or more computers to perform operations comprising: obtaining a plurality of training samples; employing a set of activation functions on a plurality of layers of a deep neural network, wherein the set of activation functions varies with the plurality of layers; and applying the activation functions on the plurality of training samples.

According to a third aspect of the present invention, an apparatus comprising: at least one processor, and at least one memory including computer program code, the at least one memory and computer program code configured to, with the at least one processor, cause the apparatus to at least: obtain a plurality of training samples; employ a set of activation functions on a plurality of layers of a deep neural network, wherein the set of activation functions varies with the plurality of layers; and apply the activation functions on the plurality of training samples

### BRIEF DESCRIPTION OF THE DRAWINGS

For a more complete understanding of example embodiments of the present invention, reference is now made to the following descriptions taken in connection with the accompanying drawings in which:

FIGS. 1(a) and 1(b) illustrate the smooth activation functions of sigmoid function and the tan h function;

FIG. 2(a), FIG. 2(b) and FIG. 2(c) illustrate the smooth activation functions of ReLU, PRELU, and ELU;

FIG. 3 illustrates an example embodiment of varying the slopes of the positive part of the activation functions for different layers;

FIG. 4 illustrates an example embodiment of varying the slopes of both the positive and negative parts of the activation functions;

FIG. 5 illustrates an example embodiment of employing piece-wise activations in the former layers and smooth activation functions in the later layers; and

FIG. 6 illustrates an example computing environment for implementing the convolutional neural network techniques in accordance with some example embodiments

### DETAILED DESCRIPTION OF THE DRAWINGS

An activation function is a function h: [symbol] → [symbol] that is differentiable almost everywhere. Activation function is crucial for successful deep leaning in the sense of extracting nonlinear features. Good activation functions are important for obtaining satisfying performance of deep learning. However, if all the layers of the neural network of the deep learning algorithm employ the same activation function, the performance may be limited. There are a lot of activation functions, which can be divided into three categories: smooth activation functions, piewisie-linear activation functions, and random activation functions.

Smooth Activation Function:

The curve of a smooth activation function is very smooth. Representative smooth activation functions include sigmoid function and tan h function which are defined respectively as:

$$\begin{matrix}sigmoid ( x ) = \frac{1}{1 + {e}^{- x}} & ( 1 ) \\ tanh ( x ) = \frac{1 + {e}^{- 2 x}}{1 + {e}^{- 2 x}} & ( 2 )\end{matrix}$$

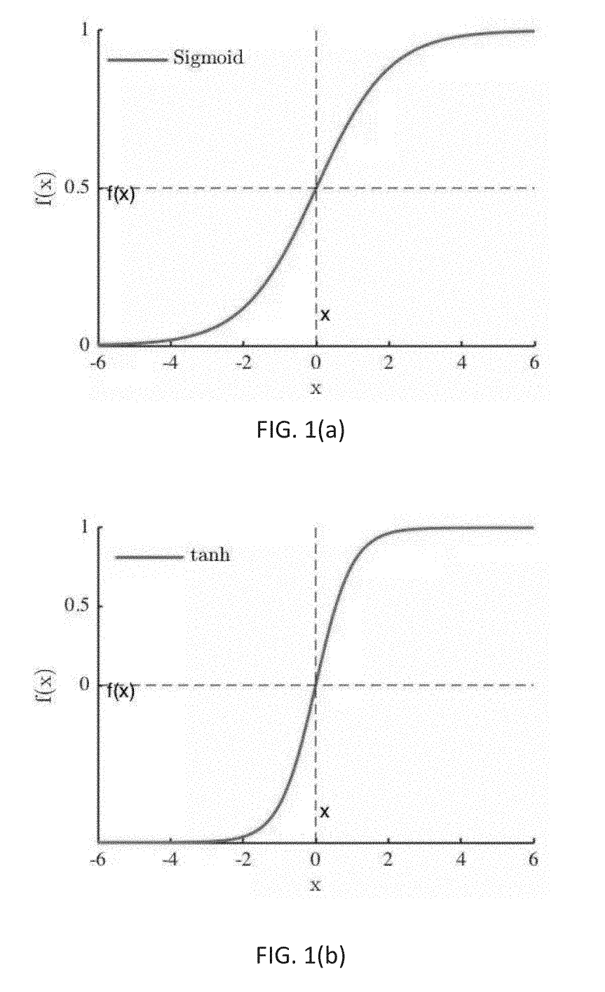

FIG. 1(a) and FIG. 1(b) illustrate the smooth activation functions of sigmoid function and the tan h function, respectively. The sigmoid function has a biological basis. The average of biological neurons, as a function of excitation, follows a sigmoidal characteristic. However, the sigmoid function leads to gradient vanishing and slow convergence in the sense of training the neural networks, especially when the depth of the neural works is large. The convergence speed of the tan h function is faster than that of the sigmoid function. However, the tan h function also encounters the problem of vanishing gradient.

Piece-Wise Linear Activation Function:

Representative piece-wise linear activation functions includes ReLU, PReLU, ELU, etc. The definitions of the RELU, PReLU, and ELU are given as follows.

$$\begin{matrix}ReLU ( x ) = \{ \begin{matrix}x , & if x \geq 0 \\ 0 , & if x < 0\end{matrix} & ( 3 ) \\ PReLU ( x ) = \{ \begin{matrix}x , & if x \geq 0 \\ α x , & if x < 0\end{matrix} & ( 4 ) \\ ELU ( x ) = \{ \begin{matrix}x , & if x \geq 0 \\ α ( exp ( x ) - 1 , & if x < 0\end{matrix} & ( 5 )\end{matrix}$$

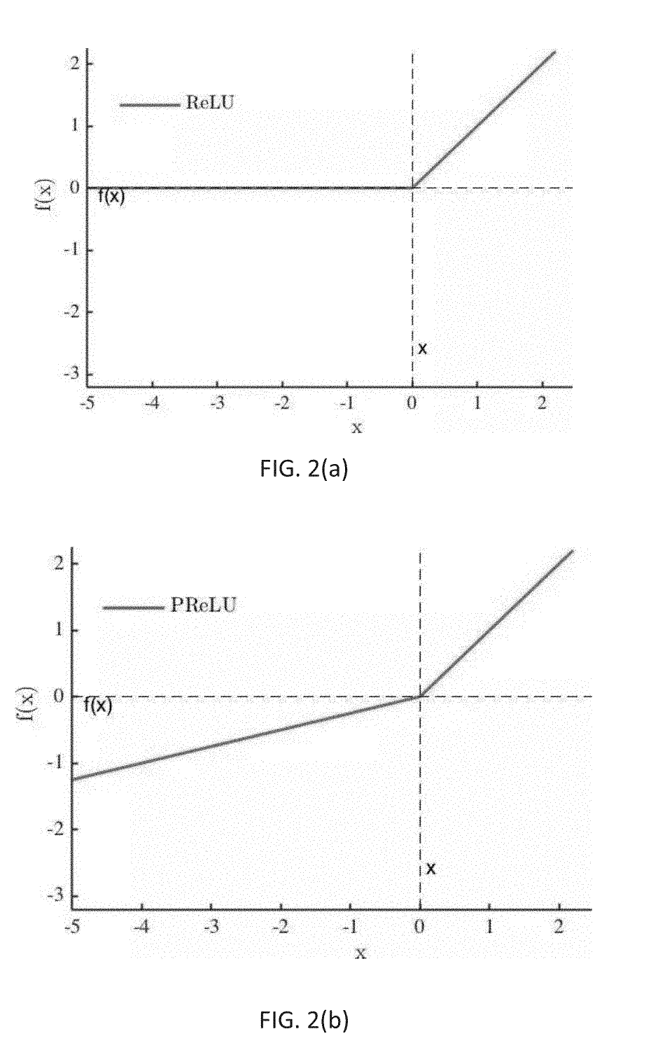

FIG. 2(a), FIG. 2(b) and FIG. 2(c) illustrate the smooth activation functions of ReLU, PRELU, and ELU. The ReLU consists of two lines. The advantage of the ReLU is able to alleviate the vanishing gradient problem. One disadvantage of ReLU is non-negative and so has a mean activation larger than zero. The other disadvantage of ReLU is the so-called bias shift effect. PReLU is an improved version of ReLU. The ELU is composed of one line and one curve with the line corresponding to the positive part of ReLU and the curve corresponding to the negative part of the Sigmoid.

Random Activation Functions:

Smooth activation functions and piece-wise linear activation functions are deterministic methods. Compared with the deterministic methods, the methods of random activation functions incur randomness into the activation function. By adding noise only to the problematic parts of the activation function, the noise activation function allows the optimization procedure to explore the boundary between the degenerate and the well-behaved parts of the activation. Because of the randomness, it is difficult for one to repeat the performance of this kind of methods. Moreover, the effect of this kind of functions is to regularize the neural network to overcome the overfitting problem when the number of training samples is small.

The above mentioned activation functions employ a single function for nonlinear activation. However, no single function is optimal in all aspects. We propose to take the advantages of the smooth activation functions and the piece-wise activation functions by utilizing several diverse activation functions in a neural network. It is noted that deep Convolutional Neural Network (CNN) is used as an example here to describe how the proposed methods may be implemented in deep learning. The proposed methods can be generalized to other deep learning algorithms.

In some example embodiments, the slopes for the positive part of the activation functions vary with layers. The angle between the line of the positive part of the standard ReLU and the horizontal axis is 45° (i.e., the slope is 1). The larger the slope, the larger the derivative. The vanishing gradient problem mainly occurs when the depth of CNN is large. For large-depth CNN, it is difficult for CNN to propagate the gradient from the last layer to the first layer. To overcome the problem, we propose generalized ReLU functions with different slopes and let the slope be small for the last layer and large for the first layer. Because the slopes of the first few activation functions are large, the powerfulness of the gradient propagation for the first few layers is large and hence the problem of vanishing gradient can be alleviated.

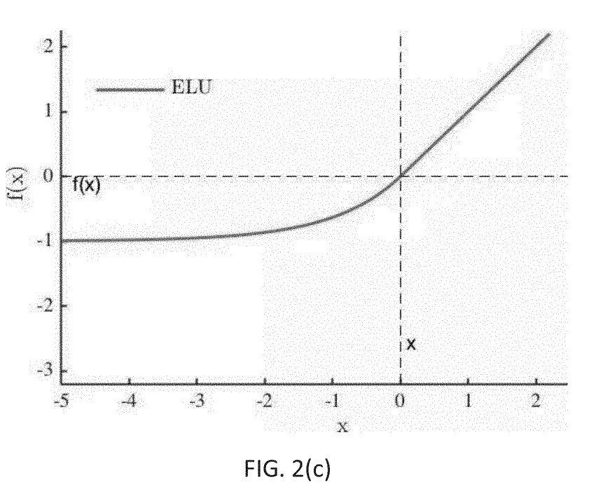

FIG. 3 illustrates an example embodiment of varying the slopes of the positive part of the activation functions for different layers when there are six convolutional layers (the depth is six). In FIG. 3, the slope of the negative part of the activation function is zero and the slope of the positive part of the activation part is positive and decreases with the layer number. The slope for the line of the positive part (right part) of the activation function can be expressed by the angle θ between the line and the horizontal axis. Let θi be the angle corresponding to layer i. In FIG. 3, the relationship of the angles are θ1>θ2>θ3>θ4>θ5>θ6. For example, one choice of the values of the angles is θ1=85, θ2=72, θ3=60, θ4=45, θ5=25, θ6=15.

In FIG. 3, the input may be images and the output may be the class label. In the training stage, training images are used as input and the error between the output and the true label of the input is computed and minimized. The parameters obtained in training stage are used for testing new image without class label. In the testing stage, the output may be the predicted class label of the input, for example, the new image.

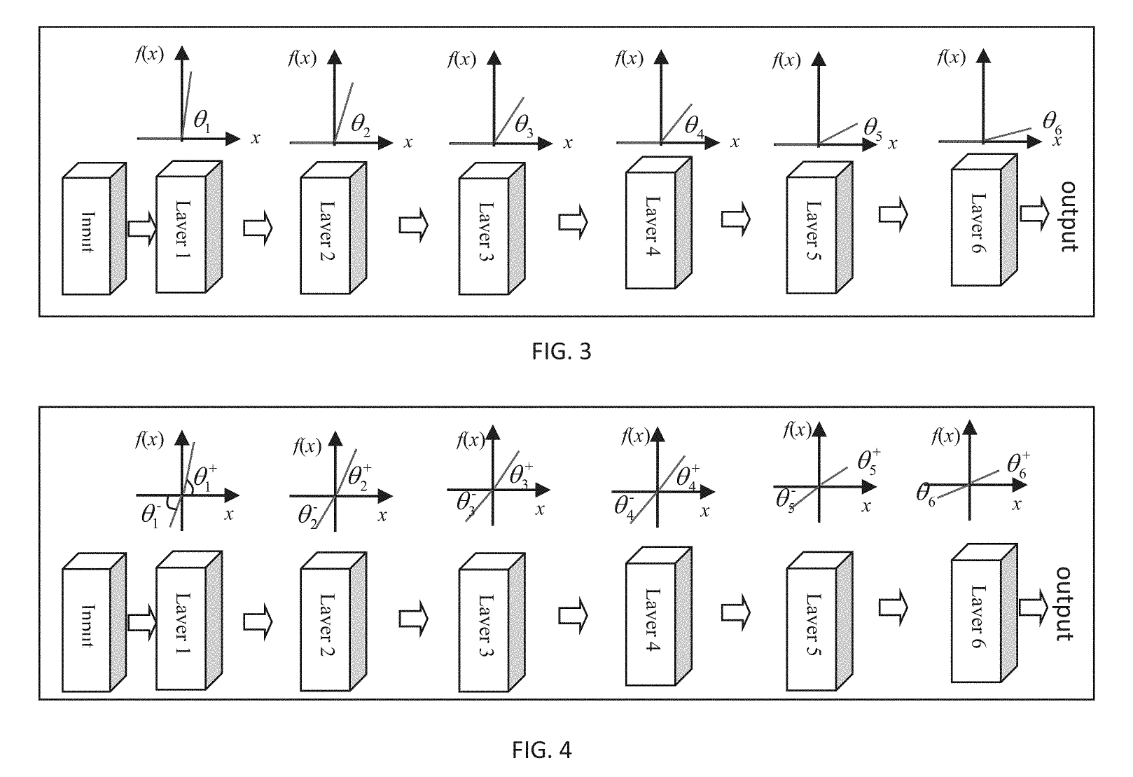

FIG. 4 illustrates an example embodiment of varying the slopes of both the positive and negative parts of the activation functions. In FIG. 4, the slopes of both the negative part and the positive part of the activation function are positive. In addition, the slopes for both the negative part and the positive part of the activation function decrease with the layer number. This method can simultaneously solve the problem of the vanishing gradient and the bias shift effect. The slope for the line of the positive part (right top part) of the activation function can be expressed by the angle θᵢ⁺ between the line and the horizontal axis where the subscript i stands for the layer number. The slope for the line of the negative part (left bottom part) of the activation function can be expressed by the angle θᵢ⁻ between the line and the horizontal axis. The relationship of the angles are θ₁⁺>θ₂⁺>θ₂⁺>θ₃⁺>θ₄⁺>θ₅⁺>θ₆⁺ and θ₁⁻>θ₂⁻>θ₂⁻>θ₃⁻>θ₄⁻>θ₅⁻>θ₆⁻ with θᵢ⁺=θᵢ⁻ or θᵢ⁺≠θᵢ⁻.

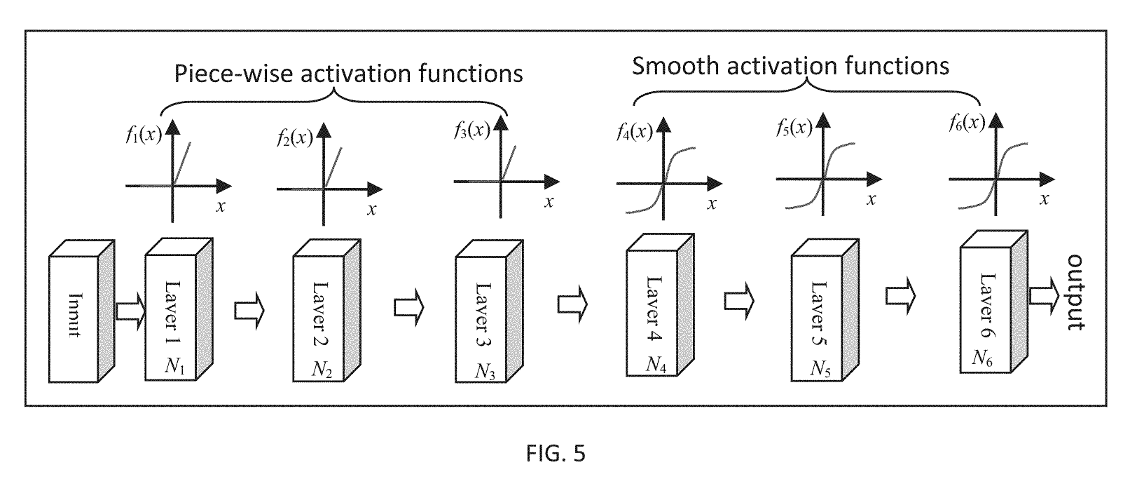

FIG. 5 illustrates an example embodiment of employing piece-wise activations in the former layers and smooth activation functions in the later layers when there are six convolutional layers (the depth is six). In FIG. 5, the first three layers adopt the piece-wise activation functions with large slopes for the positive part and the later three layers adopt the sigmoid function. The sigmoid function is biologically inspired and has many desirable properties. The first layers are prone to gradient vanishing. So we employ the piece-wise activation functions with large slopes for the first layers.

When the activation functions are chosen, the training stage of deep learning algorithm can be conducted. In some example embodiments, the input of the training stage is the training samples and their labels. The label of a training sample indicates which class the training sample belongs to. The configuration of the deep CNN may be pre-defined. For example, the configuration includes the number S of layers, the type of activation function fi in each layer i, the number Ni of feature channels of each layer i, etc. As an example, we let S=6, N1=64, N2=128, N3=256, N4=256, N5=256, and N6=100. The activations functions illustrated in FIG. 3-5 may be used for setting the activation function fi. For example, when activation functions illustrated in FIG. 5 are used, then a possible choice is letting f1, f2, and f3, be piece-wise linear function (e.g., the ReLU function):

$${f}_{i} ( x ) = \{ \begin{matrix}x , & x > 0 \\ 0 , & x \leq 0\end{matrix} , i = 1 , 2 , 3 , \qquad ( 6 )$$

and letting f4, f5 and f6, be smooth function (e.g., the Sigmoid function):

$${f}_{i} ( x ) = \frac{1}{1 + {e}^{- x}} , i = 4 , 5 , 6. \qquad ( 7 )$$

The training stage is a process that iteratively minimizes an objective function by adjusting the parameters of the networks. An objective function may be the mean squared error of the predicted labels and the underlying labels. The iterative minimization for a CNN may have two procedures: (1) from the first layer to the last layer, compute the convolution result of the network and then apply the activation function on the convolution result. (2) from the last layer to the first layer, apply the standard back-propagation algorithm for finding the optimal parameters of the network. The two procedures are conducted iteratively until a predefined number of iteration is reached.

The output (results) of the training stage are parameters of the deep CNN. With the trained (learned) parameters, an unknown sample (also called a testing sample) can be classified by the deep CNN.

The above described neural network training and testing techniques can be performed on any of a variety of devices in which digital media signal processing is performed, including among other examples, computers; image and video recording, transmission and receiving equipment; portable video players; video conferencing; and etc. The techniques can be implemented in hardware circuitry, as well as in digital media processing software executing within a computer or other computing environment, such as shown in FIG. 5.

FIG. 5 illustrates a generalized example of a suitable computing environment (600) in which described embodiments may be implemented. The computing environment (600) is not intended to suggest any limitation as to scope of use or functionality of the invention, as the present invention may be implemented in diverse general-purpose or special-purpose computing environments.

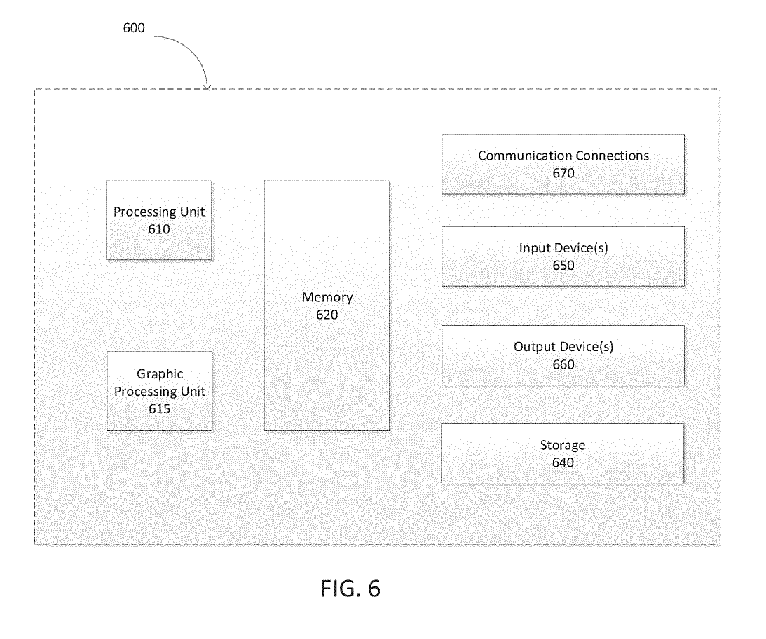

With reference to FIG. 6, the computing environment (600) includes at least one processing unit (610), a GPU (615), and memory (620). The processing unit (610) executes computer-executable instructions and may be a real or a virtual processor. In a multi-processing system, multiple processing units execute computer-executable instructions to increase processing power. The memory (620) may be volatile memory (e.g., registers, cache, RAM), non-volatile memory (e.g., ROM, EEPROM, flash memory, etc.), or some combination of the two. The memory (620) stores software implementing the described convolutional neural network training and testing techniques. The GPU (615) may be integrated with the processing unit 610 on a single board or may be contained separately.

A computing environment may have additional features. For example, the computing environment (600) includes storage (640), one or more input devices (650), one or more output devices (660), and one or more communication connections (670). An interconnection mechanism (not shown) such as a bus, controller, or network interconnects the components of the computing environment (600). Typically, operating system software (not shown) provides an operating environment for other software executing in the computing environment (600), and coordinates activities of the components of the computing environment (600).

The storage (640) may be removable or non-removable, and includes magnetic disks, magnetic tapes or cassettes, CD-ROMs, CD-RWs, DVDs, or any other medium which can be used to store information and which can be accessed within the computing environment (600). The storage (640) stores instructions for implementing the described neural network training and testing techniques.

The input device(s) (650) may be a touch input device such as a keyboard, mouse, pen, or trackball, a voice input device, a scanning device, or another device that provides input to the computing environment (600). For audio, the input device(s) (650) may be a sound card or similar device that accepts audio input in analog or digital form, or a CD-ROM reader that provides audio samples to the computing environment. The output device(s) (660) may be a display, printer, speaker, CD-writer, or another device that provides output from the computing environment (600).

The communication connection(s) (670) enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The digital media processing techniques herein can be described in the general context of computer-readable media. Computer-readable media are any available media that can be accessed within a computing environment. By way of example, and not limitation, with the computing environment (600), computer-readable media include memory (620), storage (640), communication media, and combinations of any of the above.

Without in any way limiting the scope, interpretation, or application of the claims appearing below, a technical effect of one or more of the example embodiments disclosed herein may include enabling machine learning of deep convolutional neural network.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims.

What is claimed is:

1. A method, comprising:
obtaining a plurality of training samples;
employing a set of activation functions on a plurality of layers of a deep neural network, wherein the set of activation functions varies with the plurality of layers; and
applying the activation functions on the plurality of training samples.

2. The method of claim 1, wherein the set of activation functions comprises piece-wise linear activation functions and the slopes of the positive part of activation functions vary with the plurality of layers.

3. The method of claim 2, wherein the slopes of the positive part of activation functions decrease as the layer number increases.

4. The method of claim 2, wherein the slopes of the positive part of activation functions decrease as the layer number increases, and the slopes of the negative part of activation functions decrease as the layer number increases.

5. The method of claim 1, wherein the set of activation functions comprises piece-wise linear activation functions and smooth activation functions.

6. The method of claim 5, wherein the piece-wise linear activation functions is applied before the smooth activation functions.

7. The method of claim 6, wherein the first half of the plurality of layers use piece-wise linear activation functions and the second half of the plurality of layers use smooth activation functions.

8. A non-transitory computer storage medium encoded with a computer program, the program comprising instructions that when executed by one or more computers cause the one or more computers to perform operations comprising:
obtaining a plurality of training samples;
employing a set of activation functions on a plurality of layers of a deep neural network, wherein the set of activation functions varies with the plurality of layers; and
applying the activation functions on the plurality of training samples.

9. The computer storage medium of claim 8, wherein the set of activation functions comprises piece-wise linear activation functions and the slopes of the positive part of activation functions vary with the plurality of layers.

10. The computer storage medium of claim 9, wherein the slopes of the positive part of activation functions decrease as the layer number increases.

11. The computer storage medium of claim 9, wherein the slopes of the positive part of activation functions decrease as the layer number increases, and the slopes of the negative part of activation functions decrease as the layer number increases.

12. The computer storage medium of claim 1, wherein the set of activation functions comprises piece-wise linear activation functions and smooth activation functions.

13. The computer storage medium of claim 12, wherein the piece-wise linear activation functions is applied before the smooth activation functions.

14. The computer storage medium of claim 13, wherein the first half of the plurality of layers use piece-wise linear activation functions and the second half of the plurality of layers use smooth activation functions.

15. An apparatus comprising:
at least one processor; and
at least one memory including computer program code, the at least one memory and computer program code configured to, with the at least one processor, cause the apparatus to at least:
obtain a plurality of training samples;
employ a set of activation functions on a plurality of layers of a deep neural network, wherein the set of activation functions varies with the plurality of layers; and
apply the activation functions on the plurality of training samples.

16. The apparatus of claim 15, wherein the set of activation functions comprises piece-wise linear activation functions and the slopes of the positive part of activation functions vary with the plurality of layers.

17. The apparatus of claim 16, wherein the slopes of the positive part of activation functions decrease as the layer number increases.

18. The apparatus of claim 16, wherein the slopes of the positive part of activation functions decrease as the layer number increases, and the slopes of the negative part of activation functions decrease as the layer number increases.

19. The apparatus of claim 15, wherein the set of activation functions comprises piece-wise linear activation functions and smooth activation functions.

20. The apparatus of claim 19, wherein the piece-wise linear activation functions is applied before the smooth activation functions.
